(19) United States
(12) Patent Application Publication
(10) Pub. No.: US 2008/0090599 A1
(43) Pub. Date: Apr. 17, 2008

(54) Location Specific Broadcast System and Receiver

(76) Inventors: Jagrut Patel, State College, PA (US); Sumeet Suri, San Diego, CA (US); Vittal Prabhu, State College, PA (US); Jaideep Mahalati, Kirkland, WA (US)

Correspondence Address: Vittal Prabhu, 803 Sowards Place, State College, PA, 16801, US

(21) Appl. No.: 11/869,282

(22) Filed: Oct. 9, 2007

Related U.S. Application Data
(60) Provisional application No. 60/828,958, filed on Oct. 10, 2006.

(51) Int. Cl. H04Q 7/20

(52) U.S. Cl. 455/466

(57) ABSTRACT

A broadcast system for consolidating and broadcasting the information from a broadcast server to the specific location and a communication receiver configured to receive broadcast message, determine the location of the communication receiver, and output the message to the communication device when the communication receiver is within the location specified in the received message or when the received message matches one or more criteria associated with configuration or location or unique address of the communication device. The communication receiver provides means of collecting information from the communication device and the communication device operator and presenting it to the message broadcasting entity.

### CROSS-REFERENCE TO RELATED APPLICATIONS

This application is a non-provisional application claiming benefit under 35 U.S.C. sec. 119(e) of U.S. Provisional Application Ser. No. 60/828,958, filed Oct. 10, 2006, entitled “Cellular Application for Notification and Mass Communication”, which is hereby incorporated by reference as though set forth in full.

### BACKGROUND

1. Field

The present disclosure relates generally to emergency notification systems, and more particularly, to systems and techniques for notifying large number of people over a wide spread geographic area simultaneously using cellular phones.

2. Background

In today's society, the Emergency Managers increasing relying on the telephone based mass notification systems. The service providers for such mass notification system maintain large call centers that are used by the Emergency Mangers to notify the citizen population with a voice message and/or a text message. The two biggest advantage of such telephone based notification system are 1) the notification message is delivered over telephone line which happens to be one of the most commonly and widely used communication interface thus making it easy to reach children as well as elderly population who are typically not very technologically savvy and 2) The telephone being a fixed point interface associated with a known address gives much need flexibility for Emergency Manager better manage crisis by providing location specific instructions.

There are several shortcomings associated with the both telephone based mass notification system. The telephone exchange and cellular base stations have limited number of outgoing connections which is shared between large numbers of subscribers. During emergencies, telephone based mass notification system tend to initiate large number of simultaneous calls in a small region served by one or more telephone exchanges. Once the exchange reaches its maximum connection capacity, no new calls can be placed until the existing connection is released. This limits the number of people that can be simultaneously reached using the telephone based mass notification system. Further, such telephone based mass notification system is point-to-point system thus by virtue making it sequential and venerable to single point failures. Further, there is finite number of telephone lines associated with every mass notification system typically in order of few thousand lines, which is grossly inadequate to handle large crisis involving millions of individuals.

There is a recent shift in the trend towards using SMS (Short Messaging Service) messages for providing emergency notifications. SMS bases notifications systems require lesser time to deliver information to the public and hence it can notify more people in a given time as compared to the telephone based counterpart. SMS is a point-to-point system and inherits all the disadvantages of the telephone based notification system. A typical cell site can only support maximum of ˜320 SMS msg/second. Further, SMS message occupies a Standalone Dedicated Control Channel (SDCCH) channel which is used to set-up voice calls on cellular network. Thus by flooding cellular network with SMS messages adversely affects the voice connectivity on the cellular phones. Further, cellular phones are inherently mobile. Both SMS based notification systems as well as the telephone based notification systems are point-to-point connection oriented systems that maintain cellular phone number and corresponding home location in a static database. These systems are ineffective for delivering emergency messages to the cell phone users whose present location is different from the home location stored in the static database.

### SUMMARY

An aspect of a broadcast system is disclosed. The broadcast system includes a broadcast server configured to receive message and area of interest from upstream applications, process and package the message in to location specific broadcast message, communicate the broadcast message to one or more cellular network broadcast centers.

An aspect of a broadcast system is disclosed. The broadcast system includes cellular network broad centers configured to transmit broadcast message received from broadcast server to the communication device.

An aspect of a broadcast system is disclosed. The broadcast system includes means of receiving broadcast message using the communication receiver, means of determining the location of the communication receiver and means of outputting the received message to the communication device operator only if the communication device meets one or more addressing criteria outlined in the received message.

A method of broadcasting messages to the communication devices is disclosed. The method includes embedding location information in the broadcast message, communicating the broadcast message from the broadcast server to the cellular network broadcast center, transmitting the broadcast message from the cellular base station over one or more broadcast channels, receiving the broadcast message using the communication receiver on the communication device, processing the received message to determine if the communication device meets one or more addressing criteria specified on the received message and alerting the communication device operator to the received message provided the communication device meets one or more addressing criteria specified in the received message.

A method for installing and configuring the computer readable media on the communication device is disclosed.

A method for estimating the total number of communication devices in a particular area is disclosed.

A method for estimating the total number of communication devices affiliated to a particular group such as Police, Fireman, EMA, Doctors, etc. in a particular area is disclosed.

A method for synchronizing the computer readable media with the application server is disclosed.

A method of determining the location of the communication device is disclosed.

### BRIEF DESCRIPTION OF DRAWINGS

Aspects of the present invention are illustrated by the way of example, and not by the way of limitation, in the accompanying drawings wherein:

FIG. 1 is a block diagram illustrating architecture of location specific broadcast system.

FIG. 2 is a block diagram illustrating methods of deploying computer readable media on the communication device for processing broadcast messages.

FIG. 3 is a block diagram illustrating high level overview of obtaining communication device specific computer readable software synchronization AND configuration data from the remote server.

FIG. 4 is a block diagram illustrating uplink and downlink communication between the broadcast server and communication device.

FIG. 5 is a block diagram illustrating high level overview of data transmission scheme to the communication device.

FIG. 6 is a block diagram illustrating high level overview of address decoding and processing logic for the communication device.

FIG. 7 is a block diagram illustrating high level overview of packet management schemes supported by the communication device as part of the address decoding and processing subsystem.

FIG. 8 is a block diagram illustrating high level overview of a two-way communication and acknowledgement performed between broadcast server and the communication device.

FIG. 9 is a block diagram illustrating high level overview of voice broadcast to the communication device.

FIG. 10 is a block diagram illustrating high level overview of received data presentation to the user of the communication device.

FIG. 11 is a block diagram illustrating high level overview of alerting the user to the new data received on the communication device.

### DETAILED DESCRIPTION

The detailed description is set forth below in connection with the appended drawings are intended as a description of various embodiments of the invention and is not intended to represent the only embodiments in which the invention may be practiced. The detailed description includes specific details of the purpose of providing a thorough understanding of the invention. However, it will be apparent to those skilled in the art that the invention may be practiced without these specific details. In some instances, well-known structures and components are shown in the block diagram form in order to avoid obscuring the concepts of the invention.

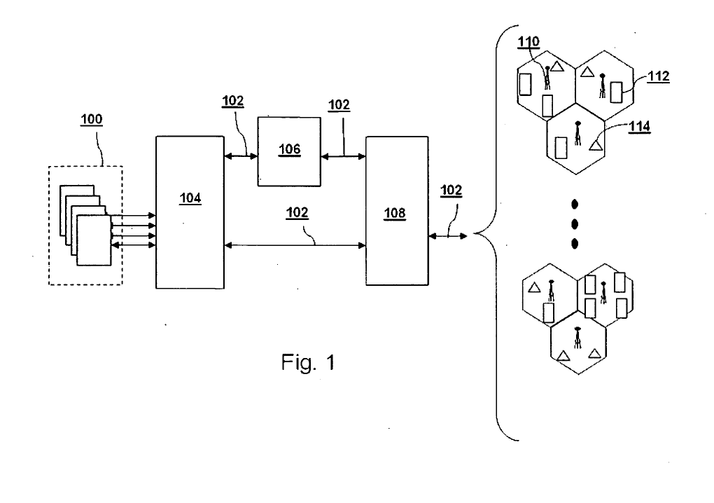

FIG. 1 illustrates end-to-end system diagram of a broadcast system. The upstream applications 100 submit the broadcast content along with area of interest to the broadcast server 104. The broadcast server 104 contains database containing the location and coverage radius of various cellular network broadcast centers 110. The broadcast server processes and packages the broadcast content received from upstream application 100 into location specific broadcast messages which is then communicated 102 to one or more cellular network broadcast centers 110 using broadcast broker 106 and cellular carrier 108. The broadcast message is then transmitted by the cellular network broadcast center 110 over one or more broadcast channels in the cell site. The communication devices 112 with communication receiver for receiving the broadcast message relayed over the broadcast channel receive the message. The communication receiver of the communication device 112 processes the received message, determines if the communication device 112 meets one or more addressing criteria specified in the broadcast message, and when the communication device 112 meets the addressing criteria specified in the received message, the communication receiver outputs the message to the communication device 112. The other devices 114 in the carrier network that does not have the communication receiver are indifferent to the broadcast messages transmitted by the cellular network broadcast centers 110. Although described in terms of broadcast messages, the techniques described herein may be applied to broadcast of text, picture, audio, video and data to the communication device 112. Further, the broadcast system may be used to transmit emergency messages, advertisement content, programming content, software upgrades, promotions, coupons, etc. The broadcast message may be delivered using but not limited to following broadcast channels: SMS Cellular Broadcast (SMSCB), Cell Broadcast, Media Forward Link Only (MediaFLO), Digital Video Broadcast (DVB), Multimedia Broadcast Multicast Subsystem (MBMS), etc.

The broadcast server 104 is a collection of hardware and software that has ability to receive broadcast content from the upstream applications 100 along with the area of interest in which the broadcast content is to be distributed, package the broadcast content to suite the requirements of the cellular network 108 and deliver the content to the cellular network broadcast center 110 for transmission to the communication device 112. Sometimes to reduce complexity of the operation, the broadcast server 104 uses broadcast broker 106 to deliver the packaged broadcast messages to the cellular network broadcast centers 110. The broadcast server 104 packages the broadcast content with appropriate address and control information. It shall be apparent to those skilled in the art that upstream applications 100 represent processes, software, client accounts, etc. that has privilege to distribute broadcast content to the communication devices 112 in the carrier network 108. Further, depending on the implementation, broadcast server 104 or the broadcast server 104 and broadcast broker 106 deliver the broadcast content from the upstream applications to the cellular network 108 or the cellular network broadcast centers. For example, in CDMA networks, the broadcast message is delivered to Mobile Switching Center (MSC) whereas for GSM networks, the broadcast message is delivered to the Base Station Controller (BSC). The broadcast server 104 can interface to the cellular network broadcast center 110 belonging to plurality of cellular networks 108 regardless of the communication standard supported by the cellular network 108.

The communication device 112 and other device 114 may take the form of any of a variety of wireless equipment, such as a mobile wireless telephone, a wireless computer, a personal digital assistant (PDA) with wireless communication capabilities and the like. Further it shall be apparent to those skilled in the art that communication receiver can be realized as combination of Hardware and Software on the communication device 112 that can receive the broadcast messages, process the received messages, and present the received messages when the conditions are right to the communication device 112 operator.

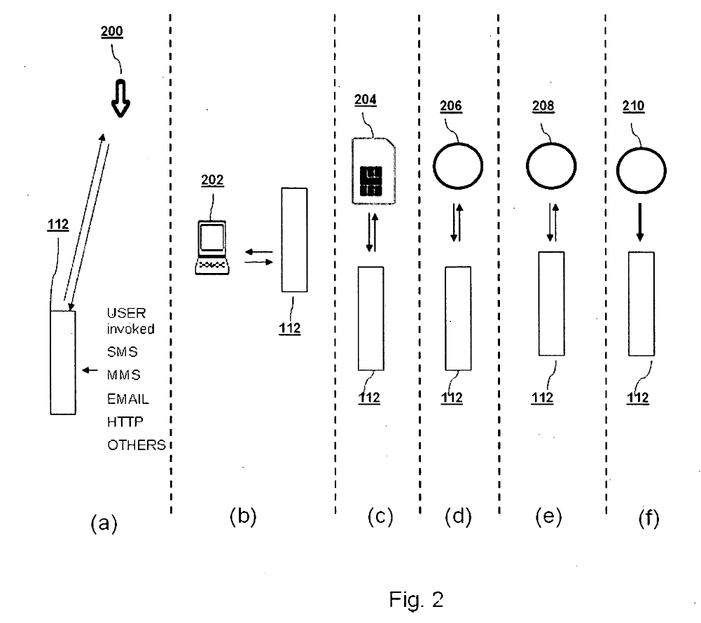

FIG. 2 illustrates the software aspect of the communication receiver in the communication device 112 may be deployed by several different approaches: web download 200, Cradle Cable 202, pre-installed on SIM 204, pre-installed OEM (communication device 112) Manufacturer 206, Carrier Distribution 208 and Carrier Push 210. All of the illustrated approaches are widely used in the cellular industry today. Further, it shall be apparent to those skilled in the art that the software aspect of the communication receiver may reside in the communication device 112 memory or the SIM memory 204.

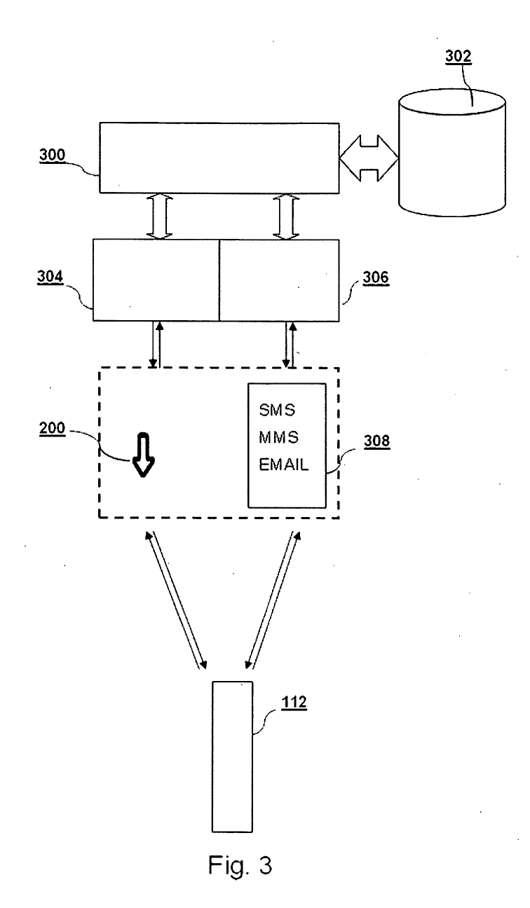

FIG. 3 illustrates a method of synchronization and configuration of the communication receiver for the communication device 112 with the application server 300. This would enable a generic version of software required for communication receiver of the communication device 112 to be distributed OR installed on the communication device 112 and the operator specific customization occurs during the synchronization operation with the application server 300. It shall be apparent to those skilled in the art that the illustration is one of the ways of configuring/customizing the said software.

In one embodiment, polling method is used by the communication device 112 for synchronization with the application server 300. The communication device 112 makes a data call to the application server 112 over the carrier data network 304. The application server 300 retrieves the information based on the unique ID associated with the communication device 112 and the profile stored in the database 302. The application server 300 presents the latest configuration information to the communication device 112 over the said data call.

In another embodiment, push method is used by the application server 300 for synchronization with the communication device 112. The application server 300 sends one or plurality of SMS or datagram message 306 with the configuration information to the said software on the communication device 112. It should be apparent to those skilled in the art that application server 300 may send SMS OR datagram message to the communication device 112 to trigger the said software on the communication device 112 to initiate a data call with the application server 300 to retrieve the configuration.

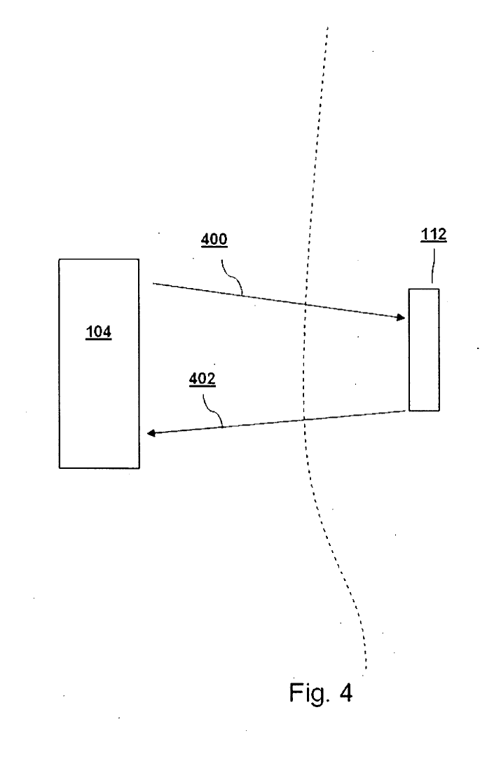

FIG. 4 illustrates the uplink 402 and downlink 400 communications between the broadcast server 104 and communication device 112. It shall be apparent to those skilled in the art that the uplink 402 communication includes but is not limited to, and with no loss of generality or specificity, SMS, MMS, EMS, Http, Web Services, Mobile IP, Socket Communication, etc. The downlink 400 communication includes but not limited to, and with no loss of generality or specificity, SMS, MMS, EMS, Http, Web Services, Mobile IP, Socket Communication, Cell Broadcast, SMSCB, DVB, MBMS, MediaFlo, etc.

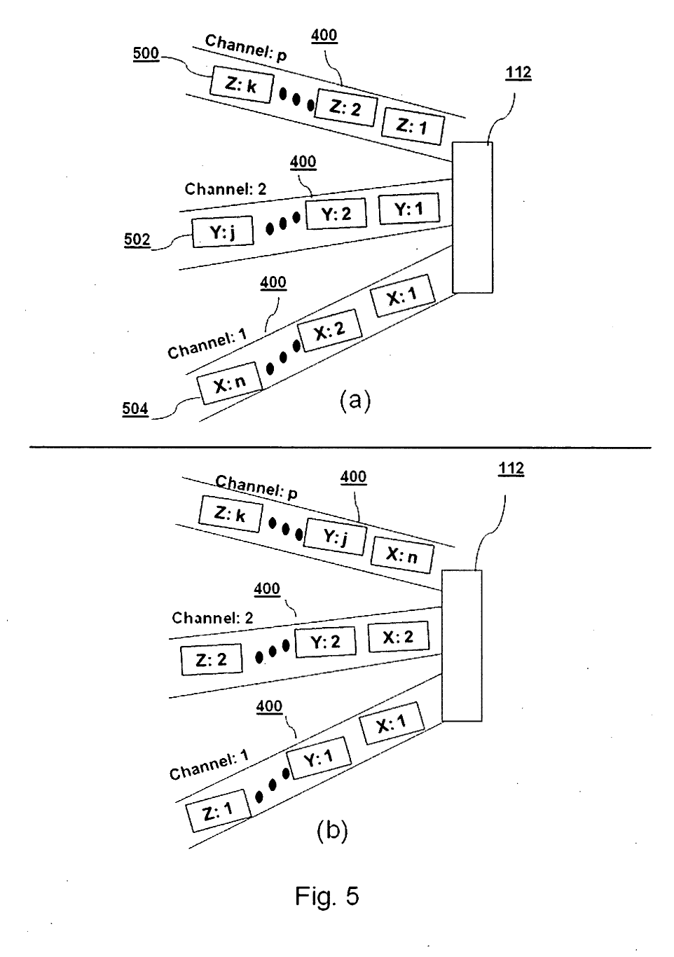

FIG. 5 illustrates the downlink 400 packets 502, 504 and 506 may be distributed over one or more broadcast channels 500. It shall be apparent to those skilled in the art that the broadcast content may be delivered in a sequential fashion (a) or spread over multiple channels (b).

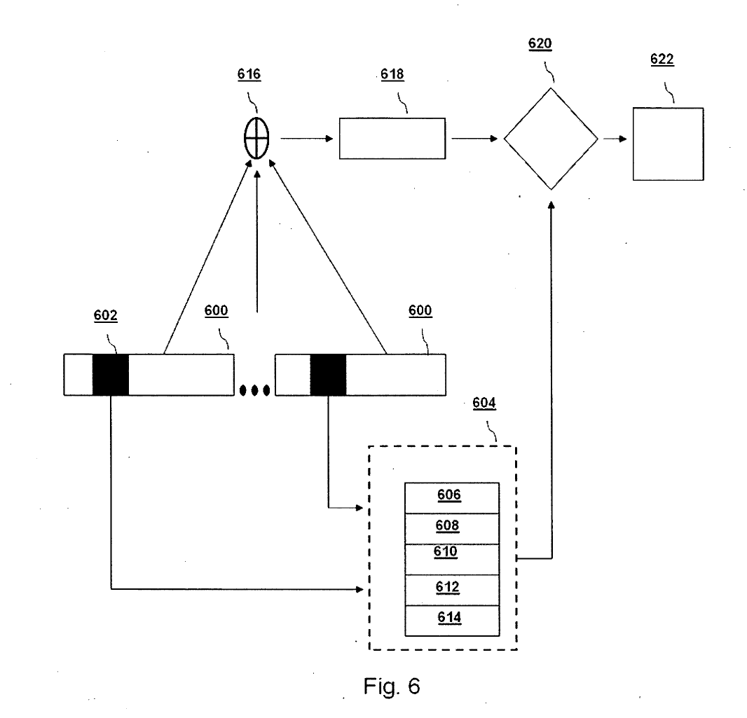

FIG. 6 illustrates data processing performed by the software aspect of the said communication receiver for the communication device 112. The communication device 112 can be addressed using combination of one or more of the following type of addressing: Own Number 606, IMEI Number 608, Unique Application ID 610, Location ID 612, Role ID 614, Organization ID 616, etc. It will be apparent to those skilled in the art that incoming message can be a single packet 600 or spread across several packets 600. The incoming broadcast message is first separated in to the Address 602 and Data portions. The Data packets split across multiple messages is assembled 616 into the original content 618. The Address 602 section containing the addressing and control parameters is processed by the address resolution logic 604. The address resolution logic 604 determines whether the received message(s) is intended for the communication device 112. The address resolution logic 604 informs the control unit 620 whether to continue further processing 622 of the received message OR discard the received message. The address resolution logic 604 determines the present location of the communication device 112 by one or more means including but not limited to Internal GPS receiver, External GPS receiver, Cell Site ID, manually entered static location, etc. As one aspect of destination address validation, address resolution logic 604 uses the present location of the communication device 112 to determine if the received broadcast message is intended for the communication device 112 operator.

For example, the upstream application 100 submits broadcast content to the Broadcast Server 104 that is an emergency message containing a picture of a suspected terrorist that is to be sent to all the Police Officers in the New York City. The broadcast server packages the said picture into plurality of broadcast packets addressed to Location ID 612: New York City and Role ID 614: Police. The broadcast server 104 then directs the said broadcast packets to all the cellular network broadcast centers 110 in the New York City. All the communication devices 112 receive the said broadcast message but only the communication devices 112 that is configured to be associated with Role ID 612: Police Officer decodes the received message and notifies the communication device 112 operators to the received message by flashing the said picture of the terrorist on the communication device 112 display. The communication device 112 that does not match the Role ID specified in the addressing field discard the said broadcast message. Further the other devices 114 that are part of the cellular network in the broadcast region are indifferent to the said broadcast message.

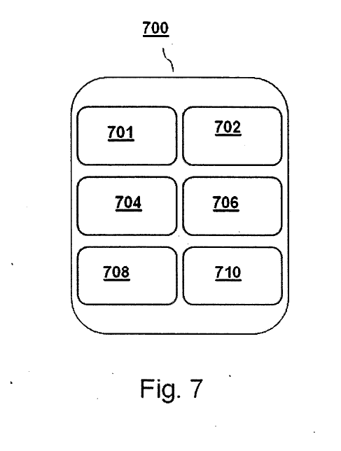

FIG. 7 illustrates message services 700 residing inside the communication device 112 as part of the further processing 622. The message services 700 may include but are not limited to, and in any combinations or parts of, Detect and Discard Repeat Messages 701, Track Message Expiry 702, Assemble incoming message 704, Delete a message 706 present in the Application inbox 708, Message Filtering 710, etc. To those skilled in the art, it will be apparent that the message services 700 can be grouped under different services in a similar type of communication receiver of the communication device 112.

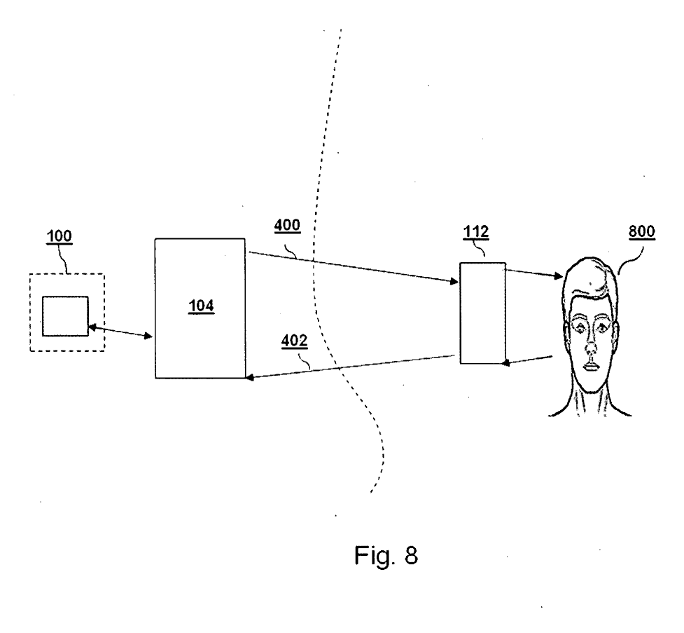

FIG. 8 illustrates the ability of upstream applications 100 to request data from the communication device 112 OR from the communication device operator 800 on downlink 400 channel, and the communication device 112 OR communication device operator 800 to respond to the said request from the said upstream application 100 over the uplink 402 channel. To those skilled in the art, it should be apparent that the requested data can be acknowledgement, location query, registration, multiple choice, etc. Further, depending on the requirements set by the upstream application 100, the communication device 112 may directly send the acknowledgement or wait for the communication device operator 800 to explicitly authorize the acknowledgement as part of feedback procedure.

For example, the said upstream application 100 can collect data from the said communication device operator 800 by posting a multiple choice question “You Prefer 1.) Coke; 2.) Pepsi; 3.) Both; 4.) None”. The communication device operator 800 can submit choice “3.) Both” to the said upstream application 100 over uplink 402 channel.

As an embodiment of the invention, upstream application 100 can request all the communication devices 112 in a given location to register with the said upstream application 100. This would provide the said upstream application 100 to estimate total number of said communication devices 112 and hence the total number of communication device operators 800 in a given area. This information can be further extrapolated to estimate total population in a given area by dividing the total number of said communication device 112 with the statistical estimate of the fraction of total population in the given area that carries the communication device 112. It shall be apparent to those skilled in the art that the invention can be used to collect information from a specific group of communication device operators 800 and that the information collected in such manner can be used to predict the number of communication device operators 800 associated with specific group.

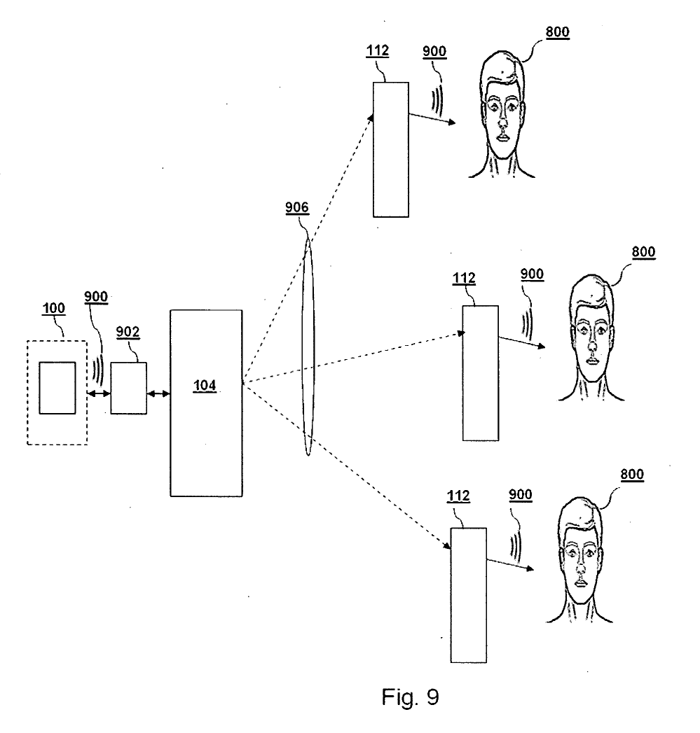

FIG. 9 illustrates voice broadcast to plurality of communication devices 112. The upstream application 100 submits voice file 900 and area of interest to the voice processor 902. The voice processor 902 converts voice into data packets is then broadcast to the communication devices 112 using the broadcast server 104 over downlink channel 400. The communication receiver software assemble the incoming broadcast message into the original voice file which is in-turn played on to the communication device 112 audio system. To those skilled in the art, the voice broadcast can be made streaming or buffered and the communication device 112 may use multimedia services to play the voice file 900 to the communication device operator 800.

In yet another embodiment the voice processor 902 converts voice file 900 into text which is then broadcast over the downlink 400 channel to the communication receiver 112. The communication receiver software on the communication device 112 converts the text received over the broadcast channel into voice using a text-to-voice converter before outputting it on the audio system of the communication device 112. It shall be apparent to those skilled in the art that upstream applications 100 may broadcast text message that is converted into voice 900 by the communication receiver software of the communication device 112 and is output on the audio system of the communication device 112.

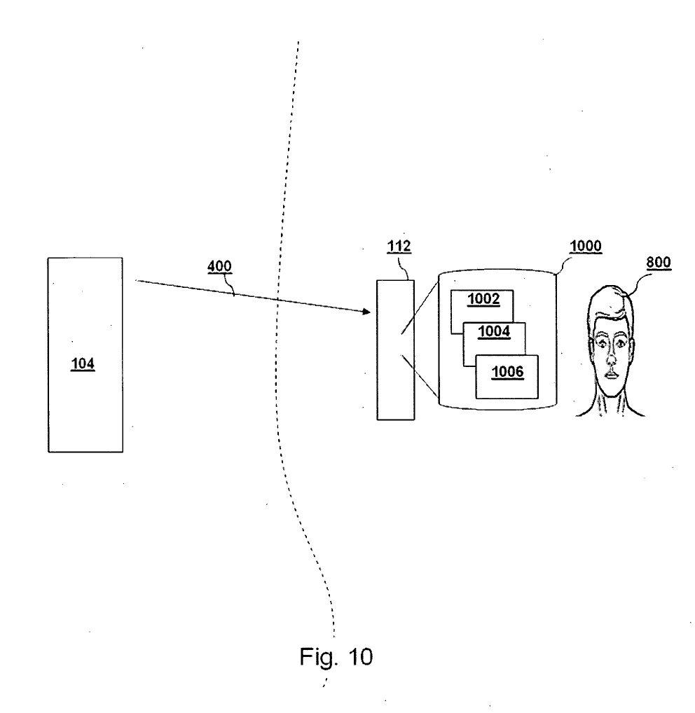

FIG. 10 illustrates means of presenting the broadcast messaged received from the broadcast server 104 over the downlink 400 channel to the communication device operator 800 by placing the received message into a mailbox 1000 on the communication device 112. It shall be apparent to those skilled in the art that said communication device 112 supports plurality of the said mailboxes 1000 such as but not limited to, SMS 1002, Email 1004, MMS 1006, etc. The technique described herein enables the communication device operator 800 to view and manipulate the information received over the broadcast channel from the familiar SMS 1002 or an Email 1004 mailbox.

For an example, the broadcast server 104 sends out an emergency alert message to the communication devices 112 in a given area over the downlink 400 channel say the Cell Broadcast Channel. A given communication device operator 800 has set Email 1004 as default mailbox 1000 interface of choice; the communication receiver software receives the emergency alert broadcast message from the Cell Broadcast Channel and saves the received message in the Email 1004 mailbox of the said communication device 112.

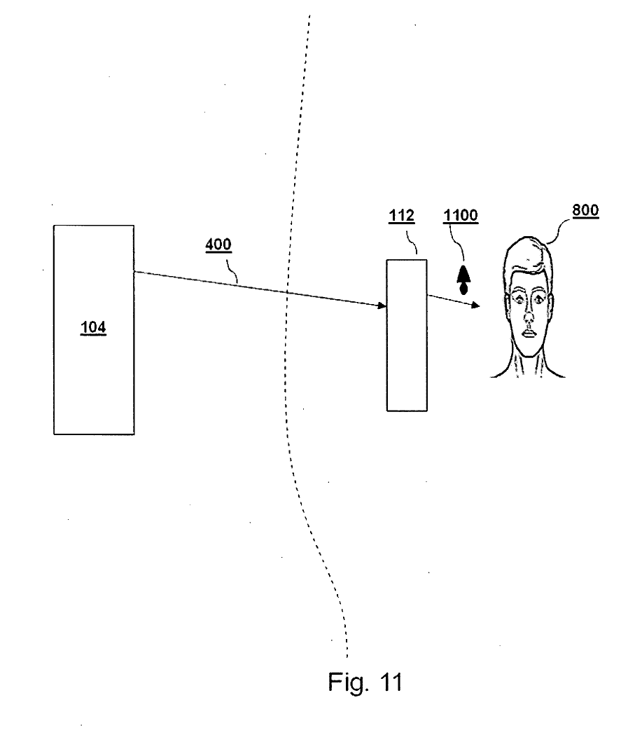

FIG. 11 illustrates means of notifying the communication device operator 800 to the received broadcast message. The broadcast server 104 optionally embeds Alert Level to describe the severity/importance of the broadcast message. The communication receiver software decodes the Alert Level and depending on the setting generates unique audible tone 1100 on the communication device 112. It will be apparent to those skilled in the art that different audible tones 1100 may be associated with different Alert Level settings. Further, the said software may cause the said communication device 112 to flash the back light on the LCD display as well as cause the communication device 112 to vibrate.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language of the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A broadcast system, comprising:
a broadcast server configured to receiving a message and area of interest from upstream applications, processing and packaging the message into one or more location specific messages; managing the interaction with the cellular network broadcast centers; communicating the packaged location specific message(s) to the one or more cellular network broadcast centers;
a cellular network broadcast center configured to broadcast message to all the communication devices in a specific location;
a communication receiver configured to receive broadcast message, determine the location of the communication device, and output the message to the communication device when it is located within the location specified by the received broadcast message or when it meets one or more criteria specific to the communication device.

2. The broadcast system in claim 1 wherein broadcast system is used to communicate information such as but not limited to emergency alert messages, advertisement messages, public announcements, programming content, images, video mail, voice message, text message, etc.

3. The broadcast system in claim 2 wherein broadcast message is an emergency alert message.

4. The broadcast system in claim 2 wherein the cellular network broadcast centers relay broadcast messages to one or more cell sites.

5. The broadcast system in claim 2 wherein the broadcast message may contain area of interest information encoded in the broadcast message.

6. The broadcast system in claim 2 wherein the broadcast message may contain group information encoded in the broadcast message.

7. The broadcast system in claim 6 wherein the communication receiver outputs the received broadcast message to the communication device if the group information on the received broadcast message matches the group information configured in the communication receiver.

8. The broadcast system in claim 6 wherein the communication receiver outputs the received broadcast message to the communication device only if the group information on the received broadcast message matches the group information configured in the communication receiver and the communication device is located within the area of interest specified in the received broadcast message.

9. The broadcast system in claim 2 wherein the broadcast server communicates the broadcast message only to one or more cellular broadcast network centers located within the area of interest.

10. The broadcast system in claim 2 wherein broadcast message is a configuration message for the communication device.

11. The broadcast system in claim 2 wherein broadcast message is a multiple choice message for the communication device.

12. The broadcast system in claim 2 wherein broadcast message is a query message for the communication device.

13. The broadcast system in claim 1 wherein upstream applications communicate message and area of interest to the broadcast server.

14. The broadcast system in claim 1 wherein the broadcast server maintains database containing location and coverage information of cellular network broadcast centers.

15. The broadcast system in claim 1 wherein the message from upstream application is packaged into one or more broadcast messages.

16. The broadcast system in claim 15 wherein the broadcast message contains the area of interest information embedded in the message.

17. The broadcast system in claim 16 wherein the area of interest is expressed as GPS coordinates and Radius.

18. The broadcast system in claim 1 wherein the broadcast server communicates broadcast message to the communication receiver over a GSM network.

19. The broadcast system in claim 1 wherein the broadcast server communicates broadcast message to the communication receiver over a CDMA network.

20. The broadcast system in claim 1 wherein the broadcast server communicates broadcast message to the communication receiver over a WCDMA network.

21. The broadcast system in claim 1 wherein the cellular network broadcast center is a component of the Base Station Controller (BSC).

22. The broadcast system in claim 1 wherein the cellular network broadcast center is a component of the Mobile Switching Center (MSC).

23. The broadcast system in claim 1 wherein the broadcast message is sent over the Broadcast Control Channel (BCCH).

24. The broadcast system in claim 1 wherein the broadcast message is sent over the Multimedia Broadcast Multicast Service (MBMS).

25. The broadcast system in claim 1 wherein the broadcast message is sent over the MediaFLO's IP Datacast stream.

26. The broadcast system in claim 1 wherein the broadcast message is sent over the Short Messaging Service Cellular Broadcast (SMSCB).

27. The broadcast system in claim 1 wherein the communication device is a cellular phone.

28. The broadcast system in claim 27 wherein the location of the communication device is determined using a GPS receiver.

29. The broadcast system in claim 27 wherein the location of the communication device is determined using Cell Site ID.

30. The broadcast system in claim 27 wherein the location of the communication device is manually entered by the communication device operator.

31. The broadcast system in claim 27 wherein the broadcast server communicates messages downlink using the broadcast channel or point-to-point channels.

32. The broadcast system in claim 27 wherein the communication device communicates operator messages, status checks and acknowledgement messages uplink to broadcast server using the SMS, datagram, data call, IP socket communication, etc.

33. The broadcast system in claim 27 wherein the received message is output as voice to the device operator by using text-to-voice converter.

34. The broadcast system in claim 27 wherein the device operator is alerted to the received message using alert tone.

35. The broadcast system in claim 27 wherein device outputs different alert tones based on the severity of the received message.

36. The broadcast system in claim 1 wherein the communication receiver consists of hardware and software required to receive; process; and output the broadcast message on the communication device.

37. The broadcast system in claim 36 wherein the software is downloaded by the communication device operator from the website.

38. The broadcast system in claim 36 wherein the software is pushed by the cellular carrier on to the communication device.

39. The broadcast system in claim 36 wherein the software is pre-installed by the cellular phone manufacturer.

40. The broadcast system in claim 36 wherein the software is configured by making data call to the application server.

41. The broadcast system in claim 36 wherein the software is configured by sending SMS messages or datagram from the application server.

42. The broadcast system in claim 36 wherein the received message is filtered for expiry, duplicate broadcast, priority, checksum, etc.

43. A method of broadcasting location specific messages from the broadcast server to the communication device; software for processing the message on the communication device; software for determining whether the received message matches one or more addressing criteria of the communication device; and software for outputting the message to the communication device if the received message matches the specified addressing criteria.

44. The method in claim 43 wherein the broadcast server encodes area of interest information into the broadcast message.

45. The method in claim 43 wherein the broadcast server communicates broadcast messages to one or more cellular network broadcast centers.

46. The method in claim 43 wherein the broadcast server manages the broadcast of messages by the cellular network broadcast centers.

47. The method in claim 43 wherein the broadcast server request communication device for information.

48. The method in claim 47 wherein broadcast server receives automatic response from the communication device for the requested information.

49. The method in claim 48 wherein the automatic response from communication device is used to estimate the total number of devices in a particular area.

50. The method in claim 48 wherein the automatic response from the communication device is used to estimate the total number of devices that belong to a particular group or category such as but not limited to police, fireman, EMA, Doctors, etc. in a particular area.

51. The method in claim 43 wherein the software is downloaded on the communication device from the website.

52. The method in claim 43 wherein the software is pushed to the communication device.

53. The method in claim 43 wherein the software is pre-installed by the manufacturer.

54. The method in claim 43 wherein the software receives update by making data call to the application server.

55. The method in claim 43 wherein the application server updates software over SMS message or datagram packets.

56. The method in claim 43 wherein the software resides on communication device memory.

57. The method in claim 43 wherein the software resides on SIM card memory.

58. The method in claim 43 wherein the received message is output to the device operator by placing the receive message into the SMS mailbox on the communication device.

59. The method in claim 43 wherein the received message is output to the device operator by placing the receive message into the MMS mailbox on the communication device.

60. The method in claim 43 wherein the received message is output to the device operator by placing the receive message into the Email mailbox on the communication device.

61. The method in claim 43 wherein the received message is output to the device operator by placing the receive message into the web-browser on the communication device.

62. The method in claim 43 wherein the received message is flashed on the device display.

63. The method in claim 43 wherein the location of the communication device is determined from a GPS receiver.

64. The method in claim 43 wherein the location of the communication device is determined from Cell Site ID.

65. The method in claim 43 wherein the location of the communication device is manually entered by the device operator.

66. A Computer-readable medium comprising instructions to receive a broadcast message: process the received message on the communication device; determine whether the received message matches one or more addressing criteria of the communication device; and output the message to the communication device only if the received message matches the specified addressing criteria.
